(19) United States
(12) Patent Application Publication
(10) Pub. No.: US 2025/0149956 A1
(43) Pub. Date: May 8, 2025

(54) CRIMPING DEVICE FOR MOTOR CORE

(71) Applicant: TOYOTA BOSHOKU KABUSHIKI KAISHA, Aichi-ken (JP)

(72) Inventors: Yasunori SAKURAI, Hashima-shi (JP); Yoshinori ISHIKAWA, Anjo-shi (JP)

(73) Assignee: TOYOTA BOSHOKU KABUSHIKI KAISHA, Aichi-ken (JP)

(21) Appl. No.: 18/928,834

(22) Filed: Oct. 28, 2024

(30) Foreign Application Priority Data
Nov. 2, 2023 (JP) 2023-188656

(51) Int. Cl. H02K 15/02; B21D 39/03

(52) U.S. Cl. CPC H02K 15/021; B21D 39/031

(57) ABSTRACT

A crimping device for a motor core is configured to crimp dowels of adjacent ones of iron core pieces by applying a load to a laminate in a thickness direction. The crimping device for the motor core includes a fixed die configured to come into contact with a first end face of the laminate and a movable die that is movable toward and away from the fixed die. The movable die is configured to apply a load to the laminate by coming into contact with a second end face of the laminate. Protrusions are provided on a surface of the movable die facing the second end face in the thickness direction. The protrusions respectively protrude toward crimp portions of the laminate.

### CROSS-REFERENCE TO RELATED APPLICATIONS

This application is based upon and claims the benefit of priority from prior Japanese Patent Application No. 2023-188656, filed on Nov. 2, 2023, the entire contents of which are incorporated herein by reference.

### BACKGROUND

### 1. Field

The present disclosure relates to a crimping device for a motor core.

### 2. Description of Related Art

Japanese Laid-Open Patent Publication No. 2021-27737 discloses a method for manufacturing a stator core. This manufacturing method includes a laminating step that laminates core plates (hereinafter referred to as iron core pieces) to form a laminate, a heat treatment step that performs heat treatment on the laminate, and a pressure applying step that applies pressure to the laminate in the thickness direction after the heat treatment step.

In the laminating step, the iron core pieces are connected to each other by crimping dowels provided on adjacent ones of the iron core pieces.

During the heat treatment step, an oxide film forms on the surface of each of the iron core pieces.

In the pressing step, a pressure applying device applies pressure to the laminate fixed to a fastener. Specifically, the pressure applying device applies a load to the laminate, which again crimps the dowels on adjacent ones of the iron core pieces. This pressure applying device has an annular upper plate that is in contact with the surface of the laminate on one side.

In such a manufacturing method, the heat treatment step reduces iron loss in the stator core. At the same time, the adjacent iron core pieces become bonded by the oxide film, leaving gaps between them in the thickness direction. Thus, the pressure applying step is performed to break the bond between the iron core pieces and reduce the gaps between the iron core pieces, ensuring that the total thickness of the laminate falls within a predetermined tolerance range.

In conventional crimping devices, including the above-described pressure applying device, the upper plate makes surface contact across the entire surface on one side of the laminate. As a result, the load applied to the laminate by the crimping device is distributed by the upper plate. Consequently, to apply enough load to reduce the gaps between the iron core pieces, the crimping device tends to become larger.

### SUMMARY

This Summary is provided to introduce a selection of concepts in a simplified form that are further described below in the Detailed Description. This Summary is not intended to identify key characteristics or essential characteristics of the claimed subject matter, nor is it intended to be used as an aid in determining the scope of the claimed subject matter.

A crimping device for a motor core according to an aspect of the present disclosure is provided. A laminate includes iron core pieces laminated in a thickness direction of the iron core pieces. Each of the iron core pieces includes dowels that bulge toward one side in the thickness direction. The laminate includes crimp portions that are respectively formed by the dowels that are overlapped with each other in the thickness direction. The crimping device is configured to crimp the dowels of adjacent ones of the iron core pieces by applying a load to the laminate in the thickness direction. The crimping device includes a fixed die configured to come into contact with a first end face of the laminate and a movable die that is movable toward and away from the fixed die. The movable die is configured to apply a load to the laminate by coming into contact with a second end face of the laminate. The second end face is located on a side opposite to the first end face. Protrusions are provided on a surface of the movable die facing the second end face in the thickness direction. The protrusions respectively protrude toward the crimp portions of the laminate.

Other features and aspects will be apparent from the following detailed description, the drawings, and the claims.

### BRIEF DESCRIPTION OF THE DRAWINGS

FIG. 1 is a perspective view of a stator core according to an embodiment.

FIG. 2 is an enlarged cross-sectional view showing part of the cross-section taken along line 2-2 of FIG. 1.

FIG. 3 is a flowchart illustrating the procedure for manufacturing the stator core shown in FIG. 1.

FIG. 4 is a cross-sectional view illustrating the crimping step.

FIG. 5 is a cross-sectional view illustrating the annealing step.

FIG. 6 is a cross-sectional view of the crimping device used in the re-crimping step.

FIG. 7 is a bottom view of the movable die of the crimping device shown in FIG. 6.

FIG. 8 is a cross-sectional view corresponding to FIG. 6, illustrating the re-crimping step.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

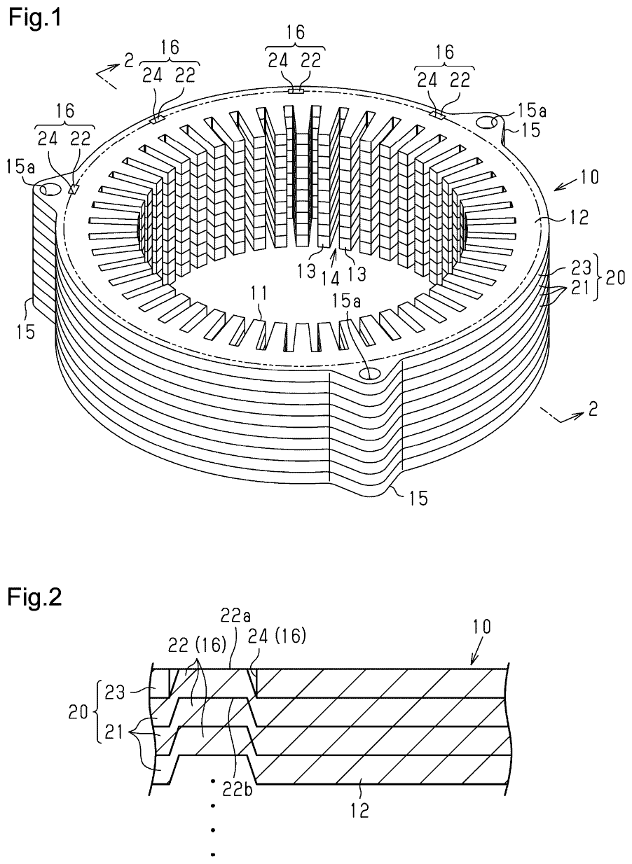

A crimping device for a motor core according to an embodiment will now be described with reference to FIGS. 1 to 8. In the present embodiment, the present disclosure is employed as a crimping device for a stator core.

### Stator Core 10

As shown in FIG. 1, a stator core 10 has a substantially cylindrical shape having a central hole 11. The stator core 10 is formed by a laminate 10A that includes iron core pieces 20 laminated in the thickness direction of the iron core pieces 20. Each iron core piece 20 is formed from an electrical steel sheet.

Hereinafter, the radial direction of the stator core 10 will simply be referred to as the radial direction, and the circumferential direction of the stator core 10 will simply be referred to as the circumferential direction.

The stator core 10 includes an annular yoke 12 and teeth 13. The teeth 13 extend radially inward from the yoke 12 and are arranged at intervals in the circumferential direction.

A slot 14 is formed between adjacent ones of the teeth 13 in the circumferential direction. The slots 14 open inward in the radial direction and extend in the radial direction.

The outer circumferential surface of the stator core 10 includes fixing portions 15. The fixing portions 15 are used to fix the stator core 10 to the case of a rotating electric machine (not shown). The fixing portions 15 protrude radially outward from the yoke 12 and are spaced apart from each other in the circumferential direction. Each fixing portion 15 includes an attachment hole 15a that extends through the fixing portion 15 in the thickness direction. In the stator core 10 of the present embodiment, one fixing portion 15 includes one attachment hole 15a. The stator core 10 is fixed to the above-described case using bolts (not shown), which are configured to be inserted through the attachment holes 15a.

### Iron Core Pieces 20

As shown in FIGS. 1 and 2, the iron core pieces 20 include first iron core pieces 21 that are continuously laminated and one second iron core piece 23 that is laminated on one side of the first iron core pieces 21 (the upper side in the vertical direction in FIGS. 1 and 2).

The first iron core pieces 21 have the same structure. Thus, a single first iron core piece 21 will be described, and the remaining first iron core pieces 21 will not be described in detail.

Each first iron core piece 21 includes a dowel 22 that bulges toward the second iron core piece 23 in the thickness direction. The dowels 22 are each formed at a portion of the first iron core piece 21 corresponding to the yoke 12 and are arranged at intervals in the circumferential direction (see FIG. 1).

Each dowel 22 includes a projection 22a that protrudes from the surface of a corresponding first iron core piece 21 on one side (the upper side in FIG. 2) and a recess 22b at a position corresponding to the projection 22a on the surface of the first iron core piece 21 on the other side (the lower side in FIG. 2).

Adjacent ones of the first iron core pieces 21 in the thickness direction are connected by crimping the dowels 22 to each other. Specifically, adjacent ones of the first iron core pieces 21 in the thickness direction are connected by crimping and fitting the projection 22a of the dowel 22 of one first iron core piece 21 into the recess 22b of the dowel 22 of the other first iron core piece 21.

The second iron core piece 23 includes a hole 24 into which the projection 22a of each dowel 22 of the first iron core piece 21 adjacent to the second iron core piece 23 is fitted. The holes 24 are each formed at a portion of the second iron core piece 23 corresponding to the yoke 12 and are arranged at intervals in the circumferential direction (see FIG. 1). Each hole 24 is located at a position overlapping a corresponding dowel 22 in the thickness direction. The hole 24 has a rectangular shape extending in the circumferential direction.

The dowels 22 overlapped with each other in the thickness direction and the holes 24 form crimp portions 16.

### Steps for Manufacturing Stator Core 10

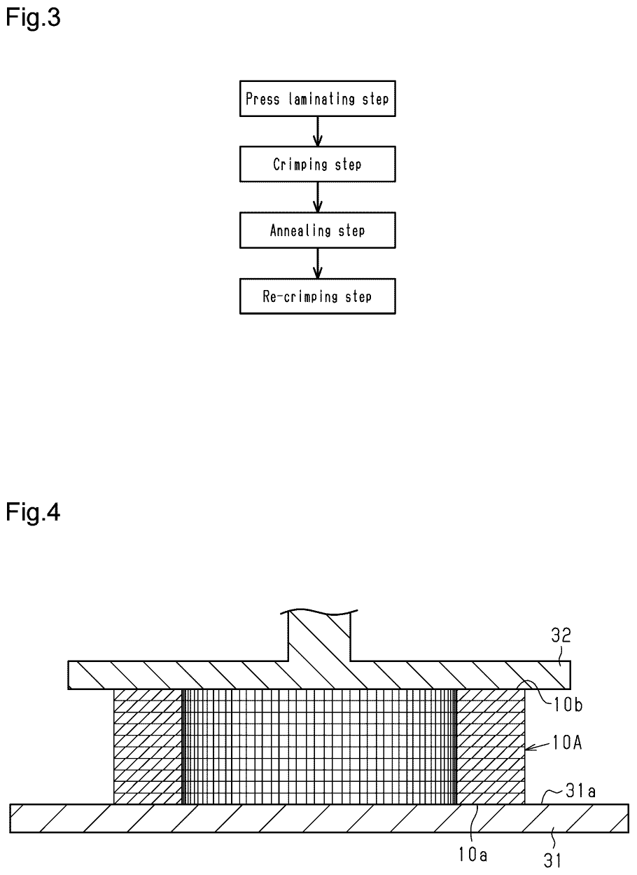

The procedure for manufacturing the stator core 10 will now be described with reference to FIGS. 3 to 8.

As shown in FIG. 3, the steps for manufacturing the stator core 10 include a press laminating step, a crimping step, an annealing step, and a re-crimping step.

The press laminating step includes a dowel forming step and a hole forming step.

The dowel forming step and the hole forming step are performed prior to a punching step that punches the iron core pieces 20 out of a workpiece.

In the dowel forming step, a pressing device is used to press the workpiece, thereby forming the dowel 22 in the portion of the workpiece that will be used as the first iron core piece 21.

In the hole forming step, the pressing device is used to press the workpiece, thereby forming the hole 24 in the portion of the workpiece that will be used as the second iron core piece 23.

In the press laminating step, multiple first iron core pieces 21 are laminated onto the second iron core piece 23, thereby forming the laminate 10A including multiple laminated iron core pieces 20.

### Crimping Step

As shown in FIG. 4, during the crimping step, a first end face 10a of the laminate 10A is first placed onto an upper surface 31a of a lower die 31. Subsequently, an upper die 32 is placed onto the second end face 10b, which is opposite to the first end face 10a. Then, the upper die 32 is pressed toward the lower die 31 to press the laminate 10A in the thickness direction. In this state, the upper die 32 and the lower die 31 apply a load having a first predetermined value P1 (e.g., 30 t) to the laminate 10A. As a result, adjacent ones of the dowels 22 in the thickness direction are crimped and each dowel 22 adjacent to a corresponding hole 24 is inserted into that hole 24 in the thickness direction.

When the pressure applied by the upper die 32 and the lower die 31 is released, a slight gap forms between adjacent ones of the iron core pieces 20 due to the spring back of the iron core pieces 20. Thus, the laminate 10A has a greater thickness than that immediately after the crimping step is performed.

### Annealing Step

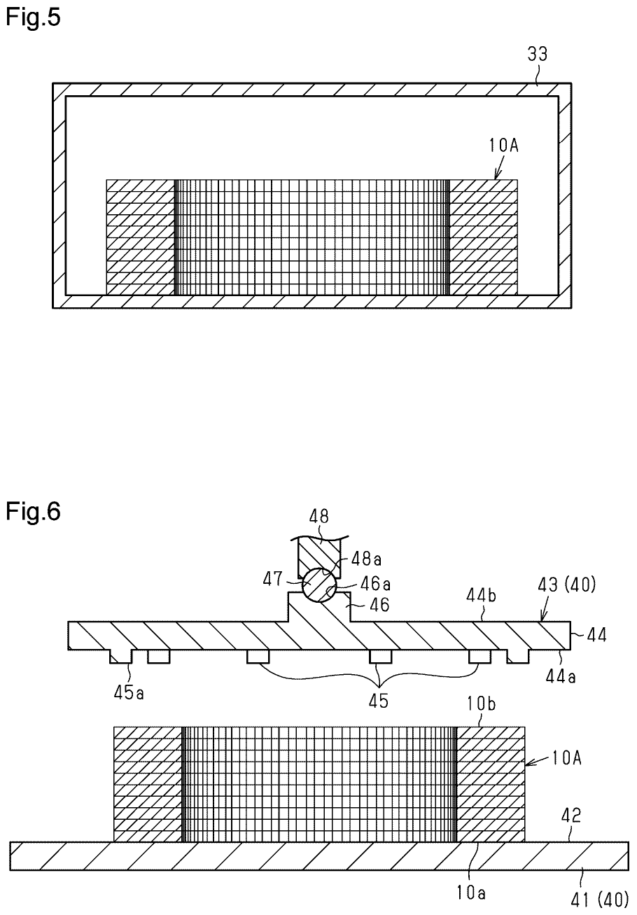

As shown in FIG. 5, in the annealing step, the laminate 10A is conveyed into a heating furnace 33. In the heating furnace 33, the laminate 10A is annealed.

The heating furnace 33 is filled with a high-temperature atmospheric gas. The atmospheric gas is a low-dew-point gas, known as DX gas, which is generated by the incomplete combustion of natural gas, followed by a dehumidifying step.

The annealing step forms an oxide film on each of the surfaces of multiple iron core pieces 20. Simultaneously, adjacent ones of the iron core pieces 20 are bonded by the oxide films, while maintaining the above-described gaps between them.

### Re-crimping Step

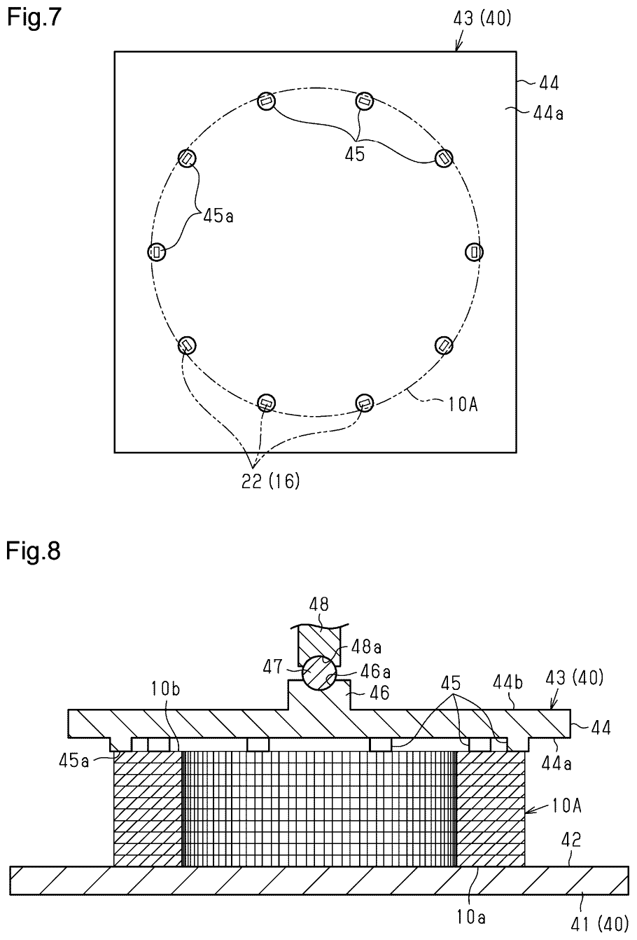

In the re-crimping step, a crimping device 40 shown in FIGS. 6 and 7 is used.

First, the crimping device 40 will be described.

As shown in FIG. 6, the crimping device 40 includes a fixed die 41 and a movable die 43 that is configured to move toward and away from the fixed die 41.

The fixed die 41 has a square shape in plan view and is placed on a table (not shown).

The first end face 10a of the laminate 10A is placed on an upper surface 42 of the fixed die 41.

As shown in FIGS. 6 and 7, the movable die 43 includes a flat portion 44 with a square shape in a plan view, which faces the second end face 10b in the thickness direction, and protrusions 45 that extend from the lower surface 44a of the flat portion 44. In FIG. 7, the general shape of the laminate 10A, which faces the lower surface 44a of the movable die 43, is shown by the long dashed double-short dashed line.

The protrusions 45 are arranged at intervals in the circumferential direction and each protrude from the lower surface 44a toward a corresponding crimp portions 16. In FIG. 6, the crimp portions 16 are not shown.

Each protrusion 45 has a tip surface 45a that is circular in plan view. Each tip surface 45a covers the entirety of a corresponding crimp portion 16 (see FIG. 7).

As shown in FIG. 6, the middle part of the upper surface 44b of the flat portion 44 includes a receiving portion 46 that protrudes upward.

The upper surface of the receiving portion 46 includes a lower support 46a that supports a sphere 47 in a manner that allows it to roll freely. The lower support 46a has the shape of a spherical recess.

The upper part of the receiving portion 46 includes an attachment 48 with an upper support 48a that supports the sphere 47 in a manner that allows it to roll freely. The upper support 48a has the shape of a spherical recess.

The attachment 48 is attached to a load applying device (not shown). The receiving portion 46 and the attachment 48 are coupled to each other by a coupling portion (not shown).

The load applying device applies a load to the laminate 10A with the movable die 43 and the fixed die 41 by lowering the movable die 43 using the attachment 48 and the sphere 47.

As shown in FIG. 8, during the re-crimping step, the crimping device 40 crimps the dowels 22 of adjacent ones of the iron core pieces 20 to each other by applying a load having a second predetermined value P2 to the laminate 10A in the thickness direction. The second predetermined value P2 is, for example, between 1 t and 2 t, inclusive.

The operation of the present embodiment will now be described.

As shown in FIG. 8, when the movable die 43 is brought closer to the fixed die 41 to apply a load to the laminate 10A, multiple protrusions 45 first come into contact with the second end face 10b of the laminate 10A. The load applied to the movable die 43 acts on the crimp portions 16 of the laminate 10A through the protrusions 45. As a result, adjacent ones of the dowels 22 of the iron core pieces 20 in the thickness direction are crimped to each other. Consequently, the gaps between multiple iron core pieces 20 are reduced.

The advantages of the present embodiment will now be described.

(1) The crimping device 40 includes the fixed die 41, which is configured to come into contact with the first end face 10a of the laminate 10A. The crimping device 40 further includes the movable die 43, which is movable toward and away from the fixed die 41. The movable die 43 is configured to apply a load to the laminate 10A by coming into contact with the second end face 10b of the laminate 10A. The protrusions 45 are provided on the lower surface 44a of the movable die 43, which faces the second end face 10b in the thickness direction. The protrusions 45 respectively protrude toward the crimp portions 16.

Such a configuration produces the above-described operation.

The above-described load is applied to each crimp portion 16 through the tip surface 45a of a corresponding protrusion 45. Thus, compared to when the load is applied to the laminate 10A with a movable die making surface contact on the entire second end face 10b of the laminate 10A, the surface pressure of the movable die 43 is larger. As a result, compared to the above-described conventional crimping device including a movable die, it is easier to achieve sufficient surface pressure for crimping adjacent ones of the dowels 22 while reducing the load applied to the movable die 43.

This prevents the crimping device 40 from being enlarged as a result of the increased load applied to the movable die 43.

(2) The tip surface 45a of each protrusion 45 covers the entirety of a corresponding crimp portion 16 in the thickness direction.

This configuration optimally applies the load to the crimp portions 16.

### Modifications

The present embodiment may be modified as follows. The present embodiment and the following modifications can be combined as long as they remain technically consistent with each other.

The shape of the tip surface 45a of each protrusion 45 is not limited to the circular shape illustrated in the present embodiment and may be changed. For example, the shape of the tip surface 45a may be elliptical in plan view or may be rectangular in plan view.

The tip surface 45a of the protrusion 45 does not have to cover the entire crimp portion 16 in the thickness direction as illustrated in the present embodiment. Instead, the tip surface 45a may cover part of the crimp portion 16 in the thickness direction.

The movable die of the present disclosure may be used in the upper die 32 in the crimping step.

This configuration allows the crimping step to achieve the advantages equivalent to the above-described (1) and (2).

The present disclosure may be employed as a crimping device used for a method for manufacturing a rotor core.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A crimping device for a motor core, wherein a laminate includes iron core pieces laminated in a thickness direction of the iron core pieces, each of the iron core pieces includes dowels that bulge toward one side in the thickness direction, the laminate includes crimp portions that are respectively formed by the dowels that are overlapped with each other in the thickness direction, and the crimping device is configured to crimp the dowels of adjacent ones of the iron core pieces by applying a load to the laminate in the thickness direction,
the crimping device comprises:
a fixed die configured to come into contact with a first end face of the laminate; and
a movable die that is movable toward and away from the fixed die, the movable die being configured to apply a load to the laminate by coming into contact with a second end face of the laminate, the second end face being located on a side opposite to the first end face, and
protrusions are provided on a surface of the movable die facing the second end face in the thickness direction, the protrusions respectively protruding toward the crimp portions of the laminate.

2. The crimping device for the motor core according to claim 1, wherein
a tip surface of each of the protrusions covers the entirety of a corresponding one of the crimp portions in the thickness direction.
